(19) United States
(12) Patent Application Publication
(10) Pub. No.: US 2021/0060646 A1
(43) Pub. Date: Mar. 4, 2021

(54) METHOD FOR FORMING PRECISE POROUS METAL STRUCTURE BY SELECTIVE LASER MELTING

(71) Applicant: CHENGDU TIANQI ADDITIVE MANUFACTURING CO., LTD., Chengdu, Sichuan (CN)

(72) Inventors: Shanfang ZOU, Chengdu (CN); Ruicheng LIU, Chengdu (CN); Liping WU, Chengdu (CN); Zhixiao ZHANG, Chengdu (CN); Anqi JIANG, Chengdu (CN)

(73) Assignee: CHENGDU TIANQI ADDITIVE MANUFACTURING CO., LTD., Chengdu, Sichuan (CN)

(21) Appl. No.: 16/763,870

(22) PCT Filed: May 22, 2018
(86) PCT No.: PCT/CN2018/087872

§ 371 Date: May 13, 2020

(30) Foreign Application Priority Data
Nov. 13, 2017 (CN) 201711116151.3

(51) Int. Cl. B22F 3/105; B22F 3/11; B22F 3/10; B22F 1/00; B22F 1/02; B33Y 10/00; B23K 26/082

(52) U.S. Cl. CPC B22F 3/1055; B22F 3/1103; B22F 3/1007; B33Y 50/02; B22F 1/02; B33Y 10/00; B23K 26/082; B22F 1/0011

(57) ABSTRACT

A method for forming precise porous metal structure by selective laser melting, including 3D design, data processing, parameter setting and selective sintering, including the following steps: A. designing 3D model of precise and porous structure; B. adding support structure and slicing; C. setting parameters of laser scanning and beam offset; and D. arranging a soft recoater in the forming system. After coating the metal powder on the forming plate, the fiber laser emits a laser to melt the metal powder to form a single-layer cross section of the porous structure; E. lowering the forming plate by one layer, and repeating steps D-E, so that the metal powder is melted and accumulated layer by layer until the formed components of porous structure are obtained.

### FIELD OF THE INVENTION

The invention relates to a method for forming precise porous metal structure by selective laser melting.

### BACKGROUND OF THE INVENTION

Biological components of porous structure are often used in the field of orthopedic implantation and, due to their complexity, are difficult to be manufactured by traditional machining. The commonly used metals for orthopedic implantation include titanium alloy and cobalt-chromium alloy, which feature poor machinability and are difficult to machine. In hot processing, they may absorb hydrogen, oxygen, nitrogen, carbon and other impurities easily, resulting in poor wear resistance and complex production process.

Selective laser melting is a process by which laser melts selective regions of a powder bed which then changes to a solid phase as it cools and layer by layer, finally form the part. The process usually includes design for the biological components, data processing for the 3D model, parameter setting, manufacturing and other processes. The process breaks through the limitations of traditional process in design and machining and can be used for forming porous metal structure. However, the existing powder bed fusion has some technical problems. For example, when manufacturing precise porous components, the hard recoater used in powder laying device can scratch fine structures of the components. The support rods of thin walls or holes of porous components, especially the edge of each hole, are prone to powder sticking during forming, resulting in rough surface. Poor accuracy of the support rod and other structures during forming will cause low accuracy of the final components, which needs further grinding and repair in the later stage.

### SUMMARY OF THE INVENTION

The invention provides a method for forming precise porous metal structure by selective laser melting. During powder laying for selective laser melting of metal, the powder laying device causing no damage to the components is used, so as to form precise porous metal structure of high precision and high performance for biological components.

The method for forming precise porous metal structure by selective laser melting in the invention includes 3D design, data processing, parameter setting and manufacturing, comprising the following steps:

A. Forming a 3D model of precise porous structure by 3D design; B. Adding a support structure to the 3D model by data processing software, and slicing the 3D model;

C. Setting the parameters of laser scanning for the sliced 3D model by the build processor software, setting the general beam offset, creating working documents and importing them into the forming system;

D. Arranging a soft recoater in the forming system and placing the metal powder into the powder chamber of the forming system. After coating the metal powder from the powder chamber on the forming plate, the laser melt the metal powder on the forming plate to form a single-layer cross section of the porous structure;

E. After one layer of single-layer cross section is completed, lowering the forming plate by one layer, and coating the metal powder from the powder chamber on the forming plate again. The fiber laser emits a laser to melt the metal powder on the forming plate to form a layer of single-layer cross section of porous structure. Determining whether the porous structure of the component has been formed. If yes, stopping the forming operation and taking out the formed part of porous structure; if no, lowering the forming plate by one layer and repeating the steps D-E according to the working document established in step C, so that the metal powder is melted and accumulated layer by layer until the formed components of porous structure are obtained.

Preferably, the support structure is dendroid, with the bottom of the trunk being located on the forming plate.

Further, inert gas is charged into the forming chamber and filtration chamber of the forming system before the fiber laser emits laser, and the concentration of oxygen in the forming chamber is controlled within the range of 0.01%-0.09% in step D.

Further, the parameter of beam offset is set to be within the range of −0.10-−0.13 mm in step C.

Further, the 3D model is downsized to 75%-80% of the theoretical size in step C.

Further, in step C, the maximum ratio of the laser power for the upper contour and the vertical contour of the 3D model to that for the down contour of the 3D model is set as 2.5, and the maximum ratio of the laser scanning speed for the upper contour and the vertical contour of the 3D model to that for the down contour of the 3D model is set as 0.67.

Specifically, the laser power for the upper contour and the vertical contour can be set as 140 W-200 W, and the scanning speed can be set as 1000 mm/s-1200 mm/s; the laser power for the down contour can be set as 80 W-120 W, and the scanning speed can be set as 1800 mm/s-2000 mm/s.

Further, during setting of the laser scanning for the core of the 3D model in step C, the maximum ratio of the laser power for the upper skin and the core to that for the down skin is set as 3.75, and the maximum ratio of the scanning speed for the upper skin and the core to that for the down skin is set as 0.67.

Specifically, during setting of the laser scanning, the laser power for the upper skin and the core is 250 W-300 W, the scanning speed is 1000 mm/s-1200 mm/s; the laser power for the down skin is 80 W-120 W, and the scanning speed is 1800 mm/s-2000 mm/s.

Further, the 3D model is a porous structure with a self-supporting structure, in which the overhanging angle of the self-supporting rod is greater than 30° and smaller than 90°, and the diameter of the self-supporting rod is 0.2-0.4 mm.

Further, in step D, the forming plate is preheated to 30° C.-40° C. before coating the metal powder on the forming plate.

Optionally, the soft recoater in step D includes a carbon fiber brush and/or a silicone rubber structure.

Further, the metal powder in step D is titanium alloy powder or cobalt-chromium alloy powder.

Preferably, the particle size of the titanium alloy powder or cobalt-chromium alloy powder is 15-45 μm.

The method for forming precise porous metal structure by selective laser melting of the invention realizes forming of precise porous structure by setting up a soft recoater in the forming system. The formed precise porous structure is of high precision, the precise part thereof will not be damaged, and the surface is smooth, so it can be effectively applied to orthopedic implantation. In addition, the method can be used to form various porous structures, and dozens of porous structures can be formed on one plate at one time, achieving a high efficiency.

The invention is further described in combination with the embodiments as follows. However, it should not be understood that the scope of the above subject of the invention is limited to the following examples. Without departing from the above technical ideas of the invention, all replacements and changes made according to the general technical knowledge and conventional means in the art shall be included in the scope of the invention.

### BRIEF DESCRIPTION OF THE DRAWINGS

FIG. 1 is a flow diagram illustrating the method for forming precise porous metal structure by selective laser melting of the invention.

FIG. 2 is a structural diagram illustrating a precise porous titanium alloy structure in Embodiment 1.

FIG. 3 illustrates the porous structure formed according to FIG. 2.

FIG. 4 is a structural diagram illustrating a precise porous cobalt-chromium alloy structure in Embodiment 2.

FIG. 5 illustrates the porous structure formed according to FIG. 4.

FIG. 6 is a structural diagram illustrating a precise porous titanium alloy structure in Embodiment 3.

FIG. 7 illustrates the porous structure formed according to FIG. 6.

### DETAILED DESCRIPTION OF THE PREFERRED EMBODIMENTS

The method for forming precise porous metal structure by selective laser melting in the invention includes 3D design, data processing, parameter setting and selective sintering, comprising the following steps:

A. Forming a 3D model of precise porous structure by 3D design.

B. Adding a support structure to the 3D model by data processing software, and slicing the 3D model;

C. Setting the parameters of laser scanning for the sliced 3D model by the build processor software, setting the general beam offset, creating working documents and importing them into the forming system. The beam offset is set to ensure the accuracy of the final component size, as the heat affected zone appearing during laser scanning will cause the actual size of the printed component to be larger than the theoretical design size. But for the precise porous structure, the beam offset value and the diameter of the rod in the porous structure are at the same level. If the beam offset value is twice larger than the rod diameter, the laser will not scan the rod after the beam offset is set, and if the rod diameter is slightly larger than twice of the beam offset value, the laser scanning area is narrow and it is not easy to form the rod. Therefore, the parameter of beam offset in step C is preferably set as −0.10-−0.13 mm. At the same time, due to the influence of thermal expansion in the forming process, the 3D model is downsized to 75%-80% of the theoretical size in order to ensure the accuracy of dimension of the formed component;

D. Arranging a soft recoater in the forming system, and placing the metal powder into the powder chamber of the forming system. After coating the metal powder from the powder chamber on the forming plate, the fiber laser emits a laser to melt the metal powder on the forming plate to form a single-layer cross section of the porous structure, wherein the metal powder can be titanium alloy powder or cobalt-chromium alloy powder, and the particle size thereof is 15-45 μm.

E. After one layer of single-layer cross section is completed, lowering the forming plate by one layer, and coating the metal powder from the powder chamber on the forming plate again. The fiber laser emits a laser to melt the metal powder on the forming plate to form a layer of single-layer cross section of porous structure. Determining whether the porous structure of the component has been formed. If yes, stopping the forming operation and taking out the formed part of porous structure; if no, lowering the forming plate by one layer and repeating the steps D-E according to the working document established in step C, so that the metal powder is melted and accumulated layer by layer until the formed components of porous structure are obtained.

The method of the invention realizes forming of precise porous structure by setting up a soft recoater in the forming system. The formed precise porous structure is of high precision, the precise part thereof will not be damaged, and the surface is smooth.

Wherein, the porous structure of the 3D model is a self-supporting porous structure formed by interlacing of the support rods of the adjacent holes in the porous structure, so that the whole porous structure can be successfully formed without the need of adding support during the forming process and will not collapse, wherein the preferable overhanging angle of the supporting rod of each hole is within the range of 30°-90°, and the diameter of the supporting rod is 0.2-0.4 mm.

In the data processing software, the support structure of the 3D model is dendroid. The dendroid support has the trunk connected with the forming plate and the branch supporting the porous structure, in which the trunk and branch can be cylindrical, conical or circular. The dendroid support can provide enough support area and strength for the porous structure, at the same time, it also occupies less area on the plate, and it can be easily removed after the structure is formed.

The parameters of laser scanning for the 3D model of porous structure mainly include the process parameters of contour and core. The contour refers to the contour of each layer in the 3D printing process and includes upper contour, vertical contour and down contour respectively in each layer. The design parameters for upper contour and vertical contour mainly focus on uniform melting and high surface quality. Therefore, higher laser power and lower scanning speed will be set. The design parameters for down contour should be such that the laser is easy to penetrate the surface, to avoid the powder sticking under the surface and slag hanging. Therefore, lower laser power and a higher scanning speed should be set. The core also includes the upper skin, core and the down skin, and parameter setting corresponds to the upper contour, vertical contour and the lower contour respectively. Therefore, in the step, the maximum ratio of the laser power for the upper contour and the vertical contour of the 3D model to that for the down contour of the 3D model is set as 2.5, and the maximum ratio of the laser scanning speed for the upper contour and the vertical contour of the 3D model to that for the down contour of the 3D model is set as 0.67. wherein the laser power for the upper contour and the vertical contour can be set as 140 W-200 W, the scanning speed can be set as 1000 mm/s-1200 mm/s, the laser power for the lower contour can be set as 80 W-120 W, and the scanning speed can be set as 1800 mm/s-2000 mm/s; for the process parameters of the core, the laser scanning parameters of the core of the 3D model are set to ensure that the maximum ratio of laser power for the upper skin and the core to that for the down skin is 3.75, and the maximum ratio of the scanning speed for the upper skin and core to that for the down skin is 0.67, wherein the laser power for the upper skin and the core can be set as 250 W-300 W, the scanning speed can be set as 1000 mm/s-1200 mm/s, the laser power for the down skin can be set as 80 W-120 W, and the scanning speed can be set as 1800 mm/s-2000 mm/s.

During powder laying, inert gas is first charged into the forming chamber and filtration chamber of the forming system to control the concentration of oxygen in the forming chamber within the range of 0.01%-0.09%, so as to protect the sintered metal powder. It is necessary to preheat the forming plate to 30° C.-40° C. before laying the powder with the powder laying device in order to reduce the damage of the powder laying device to the previous layer of sintered metal powder.

### Embodiment 1

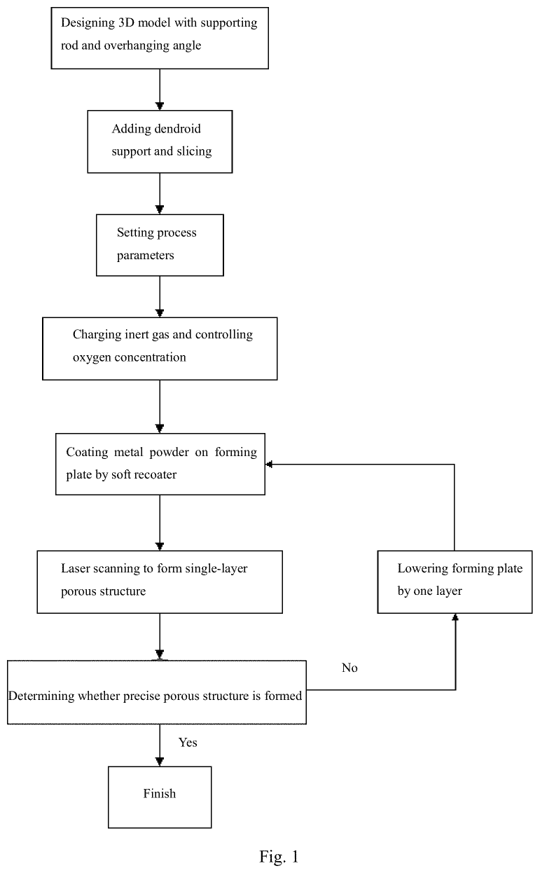

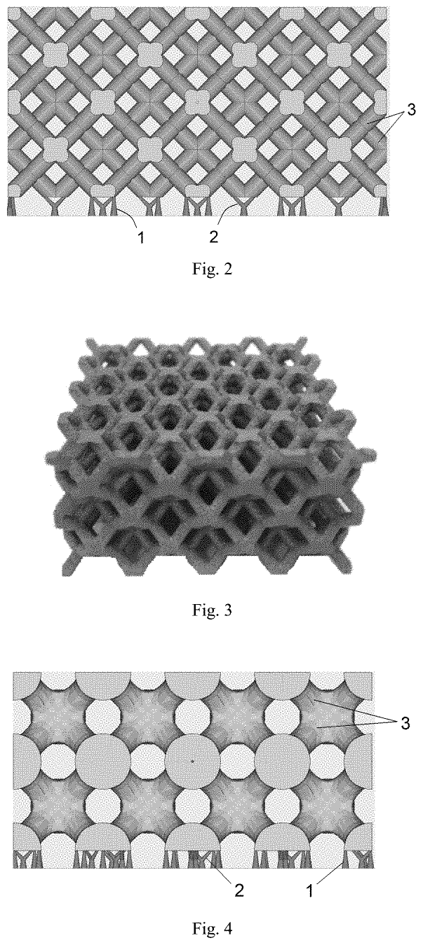

As is shown in FIGS. 1-3, the method for forming precise porous metal structure by selective laser melting in the invention includes 3D design, data processing, parameter setting and selective sintering, comprising the following steps:

A. Forming a 3D model of the precise porous structure by 3D design. The 3D model includes a self-supporting structure with a support rod 3. The overhanging angle (angle to the horizontal plane) of the support rod 3 is 45° and the diameter of the support rod 3 is 0.2 mm.

B. Adding a dendroid support to the 3D model by the Magics data processing software, and ensuring that the trunk 1 and branch 2 of the support are a circular truncated cone or a cone respectively, wherein the average diameter of the trunk 1 is 1.0 mm, and the diameter of the part of the branch 2 in contact with the porous structure is 0.6 mm; and slicing the 3D model.

C. Setting the contour and filling line parameters of the sliced 3D model by the build processor software, including laser power and scanning speed, setting the general beam offset, preparing working documents and importing them into the forming system. The contour parameters of the 3D model include: the laser power for the upper contour and the vertical contour is 150 W, the scanning speed is 1100 mm/s, the laser power for the down contour is 100 W, and the scanning speed is 1800 mm/s; the parameters of the core process include: the laser power for the upper skin and the core is 250 W, the scanning speed is 1000 mm/s, the laser power for the down skin is 80 W, and the scanning speed is 2000 mm/s; the beam offset parameter is set as −0.10 mm to ensure that the support rod 3 in the porous unit can still be scanned during beam offset; in addition, due to the influence of thermal expansion in the forming process, the 3D model is downsized to 75% of the theoretical size in order to ensure the accuracy of dimension of the formed component.

D. Setting up a soft recoater with carbon fiber brush, silicon rubber or other structures in the forming system, placing the titanium alloy powder with particle size of 15-45 μm in the powder chamber of the forming system, charging inert gas into the forming chamber and filtration chamber, and controlling the concentration of oxygen in the forming chamber to be less than 0.05%. After the forming plate is preheated to 30° C., coating the titanium alloy powder from the powder chamber on the forming plate. The laser emitted by the fiber laser is focused on the forming plate through the collimator, beam expander, oscillating mirror and F-0 lens, and the titanium alloy powder on the forming plate is melted to form a single-layer cross section of the porous structure.

E. After one layer of single-layer cross section is completed, lowering the forming plate by one layer, and coating the metal powder from the powder chamber on the forming plate again. The fiber laser emits a laser to melt the metal powder on the forming plate to form a layer of single-layer cross section of porous structure. Determining whether the porous structure of the component has been formed. If yes, stopping the forming operation and taking out the formed part of porous structure. If no, lowering the forming plate by one layer and repeating steps D-E according to the working document established in step C, so that the metal powder is melted and accumulated layer by layer until the formed components of porous structure are obtained.

### Embodiment 2

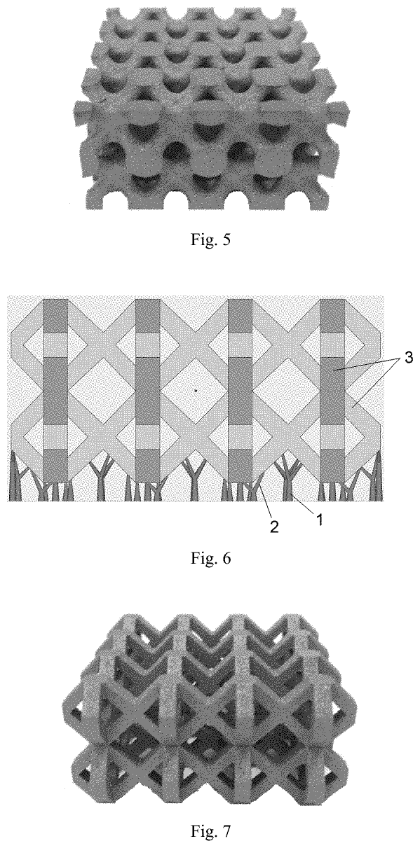

As is shown in FIGS. 1, 4 and 5, the method for forming precise porous metal structure by selective laser melting in the invention includes 3D design, data processing, parameter setting and selective sintering, comprising the following steps:

A. Forming a 3D model of the precise porous structure by 3D design, where in the 3D model includes a self-supporting structure with a support rod 3, and the overhanging angle (angle to the horizontal plane) of the support rod 3 is 45° and the diameter of the support rod 3 is 0.3 mm.

B. Adding a dendroid support to the 3D model by the Magics data processing software, and ensuring that the trunk 1 and branch 2 of the support are a circular truncated cone or a cone respectively, wherein the average diameter of the trunk 1 is 1.1 mm, and the diameter of the part of the branch 2 in contact with the porous structure is 0.7 mm; and slicing the 3D model.

C. Setting the contour and filling line parameters of the sliced 3D model by the build processor software, including laser power and scanning speed, setting the general beam offset, preparing working documents and importing them into the forming system. The contour parameters of the 3D model include: the laser power for the upper contour and the vertical contour is 180 W, the scanning speed is 1200 mm/s, the laser power for the down contour is 120 W, and the scanning speed is 1900 mm/s; the parameters of the core process include: the laser power for the upper skin and the core is 270 W, the scanning speed is 1100 mm/s, the laser power for the down skin is 100 W, and the scanning speed is 1900 mm/s; the beam offset parameter is set as −0.12 mm to ensure that the support rod 3 in the porous unit can still be scanned during beam offset; in addition, due to the influence of thermal expansion in the forming process, the 3D model is downsized to 78% of the theoretical size in order to ensure the accuracy of dimension of the formed component.

D. Setting up a soft recoater with carbon fiber brush, silicon rubber or other structures in the forming system, placing the cobalt-chromium alloy powder with particle size of 15-45 μm in the powder chamber of the forming system, charging inert gas into the forming chamber and filtration chamber, and controlling the concentration of oxygen in the forming chamber to be less than 0.02%. After the forming plate is preheated to 40° C., coating the cobalt-chromium alloy powder from the powder chamber on the forming plate. The laser emitted by the fiber laser is focused on the forming plate through the collimator, beam expander, oscillating mirror and F-0 lens, and the cobalt-chromium alloy powder on the forming plate is melted to form a single-layer cross section of the porous structure.

E. After one layer of single-layer cross section is completed, lowering the forming plate by one layer, and coating the metal powder from the powder chamber on the forming plate again. The fiber laser emits a laser to melt the metal powder on the forming plate to form a layer of single-layer cross section of porous structure. Determining whether the porous structure of the component has been formed. If yes, stopping the forming operation and taking out the formed part of porous structure. If no, lowering the forming plate by one layer and repeating steps D-E according to the working document established in step C, so that the metal powder is melted and accumulated layer by layer until the formed components of porous structure are obtained.

### Embodiment 3

As is shown in FIGS. 1, 6 and 7, the method for forming precise porous metal structure by selective laser melting in the invention includes 3D design, data processing, parameter setting and selective sintering, comprising the following steps:

A. Forming a 3D model of the precise porous structure by 3D design. The 3D model includes a self-supporting structure with a support rod 3. The overhanging angle (angle to the horizontal plane) of the support rod 3 is 45° and the diameter of the support rod 3 is 0.4 mm.

B. Adding a dendroid support to the 3D model by the Magics data processing software, and ensuring that the trunk 1 and branch 2 of the support are a circular truncated cone or a cone respectively, wherein the average diameter of the trunk 1 is 1.2 mm, and the diameter of the part of the branch 2 in contact with the porous structure is 0.8 mm; and slicing the 3D model.

C. Setting the contour and filling line parameters of the sliced 3D model by the build processor software, including laser power and scanning speed, setting the general beam offset, preparing working documents and importing them into the forming system. The contour parameters of the 3D model include: the laser power for the upper contour and the vertical contour is 140 W, the scanning speed is 1200 mm/s, the laser power for the down contour is 80 W, and the scanning speed is 1900 mm/s; the parameters of the core process include: the laser power for the upper skin and the core is 280 W, the scanning speed is 1200 mm/s, the laser power for the down skin is 80 W, and the scanning speed is 1900 mm/s; the beam offset parameter is set as −0.12 mm to ensure that the support rod 3 in the porous unit can still be scanned during beam offset; in addition, due to the influence of thermal expansion in the forming process, the 3D model is downsized to 80% of the theoretical size in order to ensure the accuracy of dimension of the formed component.

D. Setting up a soft recoater with carbon fiber brush, silicon rubber or other structures in the forming system, placing the titanium alloy powder with particle size of 15-45 μm in the powder chamber of the forming system, charging inert gas into the forming chamber and filtration chamber, and controlling the concentration of oxygen in the forming chamber to be less than 0.06%. After the forming plate is preheated to 35° C., coating the titanium alloy powder from the powder chamber on the forming plate. The laser emitted by the fiber laser is focused on the forming plate through the collimator, beam expander, oscillating mirror and F-0 lens, and the titanium alloy powder on the forming plate is melted to form a single-layer cross section of the porous structure.

E. After one layer of single-layer cross section is completed, lowering the forming plate by one layer, and coating the metal powder from the powder chamber on the forming plate again. The fiber laser emits a laser to melt the metal powder on the forming plate to form a layer of single-layer cross section of porous structure. Determining whether the porous structure of the component has been formed. If yes, stopping the forming operation and taking out the formed part of porous structure. If no, lowering the forming plate by one layer, and repeating steps D-E according to the working document established in step C, so that the metal powder is melted and accumulated layer by layer until the formed components of porous structure are obtained.

1. A method for forming precise porous metal structure by selective laser melting, including 3D design, data processing, parameter setting and selective sintering, comprising the following steps:
A. Forming a 3D model of precise porous structure by 3D design;
B. Adding a support structure to the 3D model by data processing software, and slicing the 3D model;
C. Setting the parameters of laser scanning for the sliced 3D model by the build processor software, setting the general beam offset, creating working documents and importing them into the forming system;
D. Arranging a soft recoater in the forming system, and placing the metal powder into the powder chamber of the forming system; and after coating the metal powder from the powder chamber on the forming plate, the fiber laser emits a laser to melt the metal powder on the forming plate to form a single-layer cross section of the porous structure;
E. After one layer of single-layer cross section is completed, lowering the forming plate by one layer, and coating the metal powder from the powder chamber on the forming plate again; the fiber laser emits a laser to melt the metal powder on the forming plate to form a layer of single-layer cross section of porous structure; determining whether the porous structure of the component has been formed;
if yes stopping the forming operation, and taking out the formed part of porous structure;
if no, lowering the forming plate by one layer, and repeating the steps D-E according to the working document established in step C, so that the metal powder is melted and accumulated layer by layer until the formed components of porous structure are obtained;
the maximum ratio of the laser power for the upper contour and the vertical contour of the 3D model to that for the down contour of the 3D model is set as 2.5, and the maximum ratio of the laser scanning speed for the upper contour and the vertical contour of the 3D model to that for the down contour of the 3D model is set as 0.67 in step C.

2. The method for forming precise porous metal structure by selective laser melting according to claim 1, wherein the support structure is dendroid, wherein the bottom of the trunk is located on the forming plate.

3. The method for forming precise porous metal structure by selective laser melting according to claim 1, wherein inert gas is charged into the forming chamber and filtration chamber of the forming system before the fiber laser emits laser, and the concentration of oxygen in the forming chamber is controlled within the range of 0.01%-0.09% in step D.

4. The method for forming precise porous metal structure by selective laser melting according to claim 1, wherein the parameter of beam offset is set to be within the range of −0.10-−0.13 mm in step C.

5. The method for forming precise porous metal structure by selective laser melting according to claim 4, wherein the 3D model is downsized to 75%-80% of the theoretical size in step C.

6. The method for forming precise porous metal structure by selective laser melting according to claim 1, wherein the laser power for the upper contour and the vertical contour can be set as 140 W-200 W, and the scanning speed can be set as 1000 mm/s-1200 mm/s; the laser power for the down contour can be set as 80 W-120 W, and the scanning speed can be set as 1800 mm/s-2000 mm/s.

7. The method for forming precise porous metal structure by selective laser melting according to claim 1, wherein the 3D model is a porous structure with a self-supporting structure, in which the overhanging angle of the self-supporting rod is greater than 30° and smaller than 90°, and the diameter of the self-supporting rod is 0.2-0.4 mm.

8. The method for forming precise porous metal structure by selective laser melting according to claim 1, wherein the forming plate is preheated to 30° C.-40° C. before coating the metal powder on the forming plate in step D.

9. The method for forming precise porous metal structure by selective laser melting according to claim 1, wherein the soft recoater in step D includes a carbon fiber brush and/or a silicone rubber structure.

10. The method for forming precise porous metal structure by selective laser melting according to claim 1, wherein the metal powder in step D is titanium alloy powder or cobalt-chromium alloy powder.

11. The method for forming precise porous metal structure by selective laser melting according to claim 10, wherein the particle size of the titanium alloy powder or cobalt-chromium alloy powder is 15-45 μm.

12. A method for forming precise porous metal structure by selective laser melting, including 3D design, data processing, parameter setting and selective sintering, comprising the following steps:
A. Forming a 3D model of precise porous structure by 3D design;
B. Adding a support structure to the 3D model by data processing software, and slicing the 3D model;
C. Setting the parameters of laser scanning for the sliced 3D model by the build processor software, setting the general beam offset, creating working documents and importing them into the forming system;
D. Arranging a soft recoater in the forming system, and placing the metal powder into the powder chamber of the forming system; after coating the metal powder from the powder chamber on the forming plate, the fiber laser emits a laser to melt the metal powder on the forming plate to form a single-layer cross section of the porous structure;
E. After one layer of single-layer cross section is completed, lowering the forming plate by one layer, and coating the metal powder from the powder chamber on the forming plate again; the fiber laser emits a laser to melt the metal powder on the forming plate to form a layer of single-layer cross section of porous structure; determining whether the porous structure of the component has been formed;
if yes, stopping the forming operation, and taking out the formed part of porous structure;
if no, lowering the forming plate by one layer, and repeating the steps D-E according to the working document established in step C, so that the metal powder is melted and accumulated layer by layer until the formed components of porous structure are obtained;
during setting of the laser scanning for the core of the 3D model in step C, the maximum ratio of the laser power for the upper skin and the core to that for the down skin is set as 3.75, and the maximum ratio of the scanning speed for the upper skin and the core to that for the down skin is set as 0.67.

13. The method for forming precise porous metal structure by selective laser melting according to claim 12, wherein during setting of the laser scanning, the laser power for the upper skin and the core is 250 W-300 W, the scanning speed is 1000 mm/s-1200 mm/s, the laser power for the down skin is 80 W-120 W, and the scanning speed is 1800 mm/s-2000 mm/s.

14. (canceled)
